(19) United States
(12) Patent Application Publication
(10) Pub. No.: US 2014/0338879 A1
(43) Pub. Date: Nov. 20, 2014

(54) BENDABLE HEAT READIATING COMPOSITE AND BACKLIGHT UNIT HAVING THE SAME

(71) Applicant: Ko-Chun CHEN, Kaousiung (TW)

(72) Inventor: Ko-Chun CHEN, Kaousiung (TW)

(21) Appl. No.: 14/158,285

(22) Filed: Jan. 17, 2014

Related U.S. Application Data
(63) Continuation of application No. 13/898,206, filed on May 20, 2013.

(51) Int. Cl. F21V 29/00

(52) U.S. Cl. CPC F21V 29/002; F21V 29/246
USPC 165/185

(57) ABSTRACT

A heat-transfer apparatus for dissipating heat from an electronic device is disclosed. The heat-transfer apparatus includes a composite, comprising a metal layer, a dielectric layer and one or more electrically conductive layers. The composite is plastically deformed and is substantially free of crack. A backlight apparatus comprising the heat-transfer apparatus is also provided.

This application is a continuation of and claims priority to U.S. patent application Ser. No. 13/898,206, entitled A Bendable Heat Radiating Composite and Backlight Unit Having the Same, filed on May 20, 2013, naming Ko-Chun Chen as an inventor, the entire contents of that application being incorporated herein by reference in its entirety.

### BACKGROUND OF THE INVENTION

### Background

A light-emitting diode (LED) display is a flat panel display, which includes an LED backlight unit (BLU) as a light source. As the size of such display continues to enlarge, more LEDs are used in the LED display to meet this demand.

Despite the advancements made in the display industry with larger screen, better light color and longer life, improved heat dissipation of the LED lighting has utilitarian value with respect to LED performance. This is because approximately 30% of the LED energy is converted to light, while 70% of the LED energy is converted to heat, which can affect the performance and reliability of the LED display.

### BRIEF SUMMARY

In one embodiment, there is a heat-transfer apparatus, comprising a composite. The composite 1 including a metal layer 4; a dielectric layer 3 located on the metal layer 4; and one or more electrically conductive layers 2 located on the dielectric layer 3 on an opposite side from the metal layer 4, as illustrated in FIG. 1. The composite 1 is a plastically deformed composite such that a surface of the composite at a first leg A has a first planar area that is at an angle α of a value of about 70 degrees and a value that is less than about 180 degrees, or a value of greater than about 180 degrees to a value that is less than about 360 degrees to a second planar area of a second leg B.

In an exemplary embodiment, the heat-transfer apparatus is a printed circuit board and functions as a heat dissipation device at the same time. The combination of the printed circuit board and the heat dissipation device reduces the thickness of the LED frame compared to a configuration where the heat dissipation functionality is achieved via a separate component from the printed circuit board.

In another embodiment, a back light apparatus is provided as illustrated in FIG. 7. The back light apparatus comprising a generally “L” shaped laminate 1, and one or more LEDs 7. The “L” shaped laminate 1 comprises a first leg A and a second leg B, a cross-section of the “L” shaped laminate 1 including a metal sub-section, a dielectric sub-section and an electrically conductive sub-section, each of the sections being generally “L” shaped, wherein the first leg A and the second leg B of the “L” shaped laminate 1 are connected together via a plastically deformed section C. The LED 7 is in conductive heat transfer communication with the first leg A of the “L” shaped laminate 1, and the “L” shaped laminate 1 transfer heat from the first leg A of the “L” shaped laminate 1 and then therefrom to the second leg B of the “L” shaped laminate 1, through the plastically deformed section C.

In another embodiment, a method for heat dissipation in a backlight apparatus is provided, comprising the actions of:
a) conducting heat from an LED 7 to a first leg A of a generally “L” shaped laminate 1 (as illustrated in FIG. 7);
b) conducting heat from the first leg A to a second leg B of the generally “L” shaped laminate 1 through a plastically deformed section C.

### BRIEF DESCRIPTION OF THE DRAWINGS

Other features will become apparent in the following detailed description of some embodiments with reference to the accompanying drawings, in which:

FIG. 1 illustrates schematically a longitudinal cross sectional view on the of the heat-transfer apparatus of an embodiment.

FIG. 2 illustrates schematically a transverse cross sectional view of one embodiment of the heat-transfer apparatus.

FIG. 3 illustrates schematically a transverse cross sectional view of another embodiment of the heat-transfer apparatus.

FIG. 4 illustrates schematically a transverse cross sectional view of another embodiment of the heat-transfer apparatus.

FIG. 5A and FIG. 5B are photographs illustrating various bend radius of the heat-transfer apparatus.

FIG. 6 is an assembly of microphotographs illustrating the plastically deformed section of the heat-transfer apparatus.

FIG. 7 illustrates schematically a cross sectional view of the backlight apparatus of an embodiment.

### DETAILED DESCRIPTION

### Definitions

As employed above and throughout the disclosure, the following terms, unless otherwise indicated, shall be understood to have the following meanings.

As used herein, the singular forms “a,” “an,” and “the” include the plural reference unless the context clearly indicates otherwise.

It is understood that the BLU described herein are composed of various sheets, layers, films or plates sandwiched together to form the BLU of at least some embodiments detailed herein and/or variations thereof, and such terms as sheets, layers, films, subsections or plates may be used interchangeably in conjunction with the description of at least some of the embodiments and/or variations thereof.

### The Heat-Transfer Apparatus

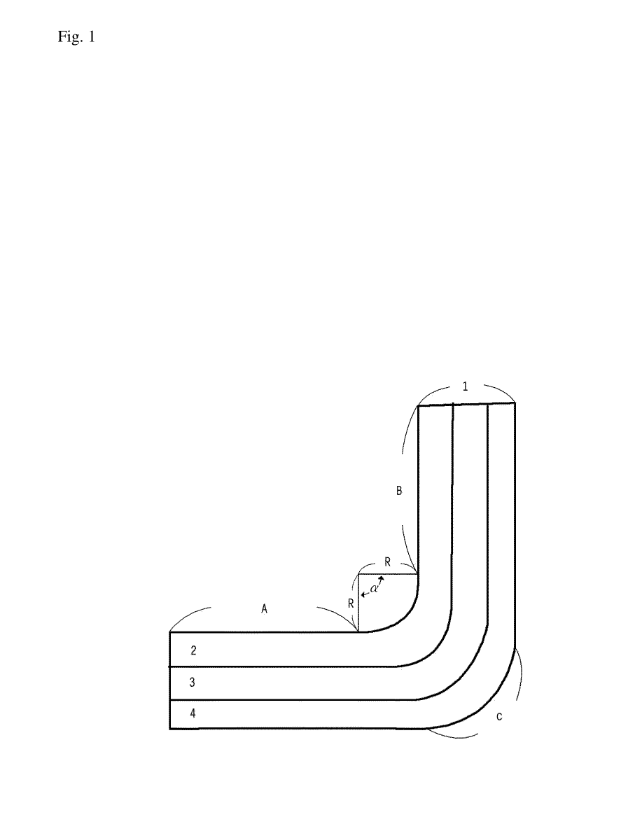

Referring to FIG. 1, in this embodiment, the heat-transfer apparatus comprises a plastically deformed composite or a generally “L” shaped laminate 1. The composite comprises a metal layer 4, a dielectric layer 3 located on the metal layer; and one or more electrically conductive layers 2 located on the dielectric layer 3 on an opposite side from the metal layer 4.

The composite 1 is manufactured by, in an exemplary embodiment, combining the metal layer 4, dielectric layer 3 and electrically conducting layer 2 in a vacuum by heat (at a temperature higher than 350 degrees C.) and pressure (about 40 Kg/cm²) into a composite 1. The strata of layers below the surface of the composite 1 extends from the first leg A to the second leg B and is generally uniform from the first leg A to the second leg B. In one embodiment, the composite 1 is substantially free of adhesive. In another embodiment, the composite 1 is substantially free of thermoplastic and/or thermosetting materials.

The composite 1 has a first leg A and a second leg B, which are substantially planar and joined by a plastically deformed section C. The first leg A of the composite 1 has a first planar area that is at an angle (α) of between a value of about 70 degrees and a value that is less than about 180 degrees, or a value that is greater than about 180 degrees to a value that is less than about 360 degrees to the second planar area of the second leg B. In one embodiment, angle α is about 90 degrees and a cross-section of the composite 1 lying on a plane substantially normal to the first planar area and the second planar area is at least in about an “L” shape. In another embodiment, angle α is an angle corresponding to the legs being substantially perpendicular.

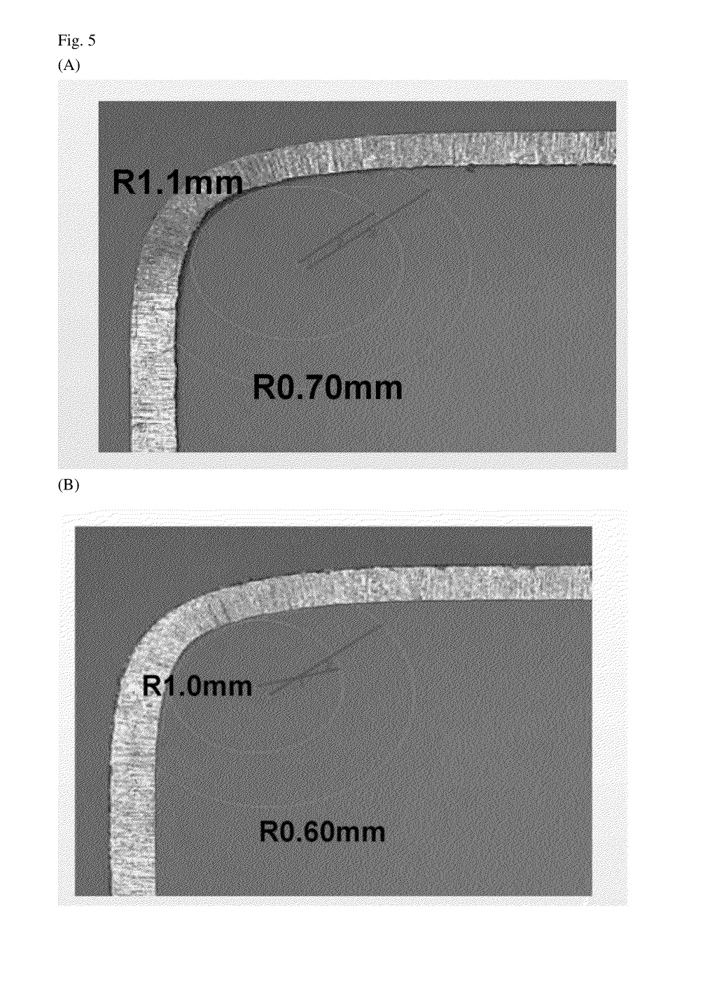

Still referring to FIG. 1, the plastically deformed section C has a bend radius R of curvature of about 0.1 mm to less than about 2.0 mm. In an exemplary embodiment, the bend radius R is equal to or less than about 1.9 mm, 1.8 mm, 1.7 mm, 1.6 mm 1.5 mm, 1.4 mm, 1.3 mm, 1.2 mm, 1.1 mm, 1.0 mm, 0.9 mm, 0.8 mm, 0.7 mm, 0.6 mm, 0.5 mm, 0.4 mm, 0.3 mm, 0.2 mm or 0.1 mm or any value or range of values therebetween in 0.01 mm increments (e.g., about 1.13 mm, about 0.49 mm, about 0.16 to about 0.56 mm, etc.). In one exemplary embodiment, as illustrated in FIG. 5A, the bend radius is about 0.7 mm. In another exemplary embodiment, as illustrated in FIG. 5B, the bend radius is about 0.6 mm. As can be seen from the Figs., the outside bend radius can be different from the inside bend radius. Accordingly, the aforementioned exemplary values for the bend radius can be applicable to the outside bend radius and/or to the inside bend radius. Accordingly, in an exemplary embodiment, there is a component that has an outside bend radius corresponding to any of the aforementioned values, and an inside bend radius corresponding to any of the aforementioned values, where the outside bend radius and the inside bend radius are different or the same. In an exemplary embodiment, the ratio of the outside bend radius to the inside bend radius is about 0.4, 0.5. 0.6. 0.7, 0.8, 0.9, 1.0, 1.1, 1.2, 1.3, 1.4 or about 1.5 and/or any value or range of values therebetween in 0.01 increments (e.g., about 0.56, about 1.33, about 0.72 to about 1.45, etc.).

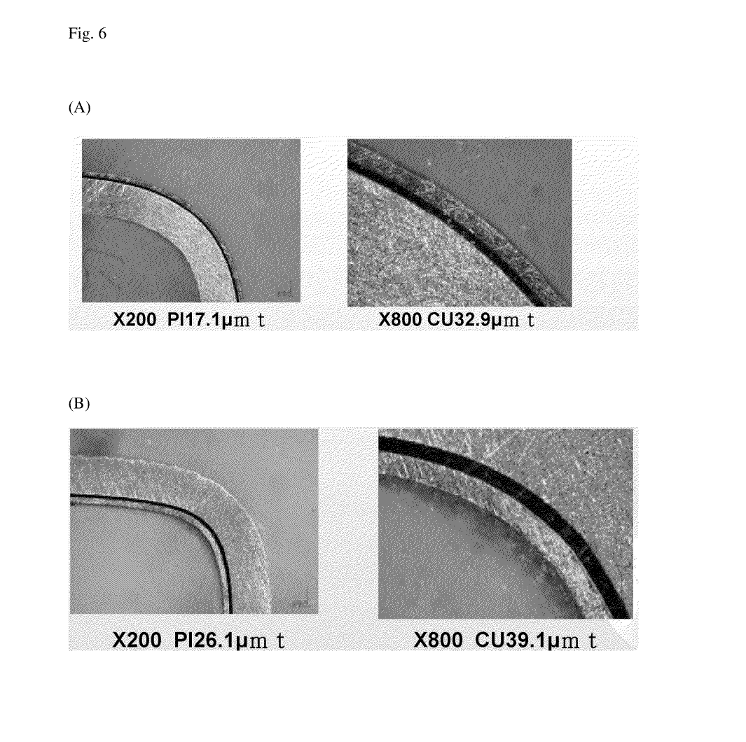

The plastically deformed section C is non-thermoplastically formed. In addition, the plastically deformed section C is substantially free of cracks, effectively free of cracks or completely devoid of cracks. In one exemplary embodiment, the presence (or, more appropriately, the absence) of cracks in the plastically deformed section C can be visually assessed by microscopy. FIGS. 6A and 6B are microscopy images illustrating that the plastically deformed section C is substantially free of cracks at 200× and 800× settings. In another embodiment, the presence of cracks in the plastically deformed section C is assessed by electricity flow between all three layers. In an exemplary embodiment, a static gun can be used to generate an electrical current (less than 1 KV (VDC) of electrostatic discharge), which is applied to the metal layer 4. The impedance over the surface of the electrically conductive layer 2 is measured using an electrical impedance meter. If the plastically deformed section C is substantially free of cracks, the electricity flow across the plastically deformed section C (i.e. from the metal layer 4 to the electrically conductive layer 2) is interrupted, and there will be no impedance detected on the surface of the electrically conductive layer 2.

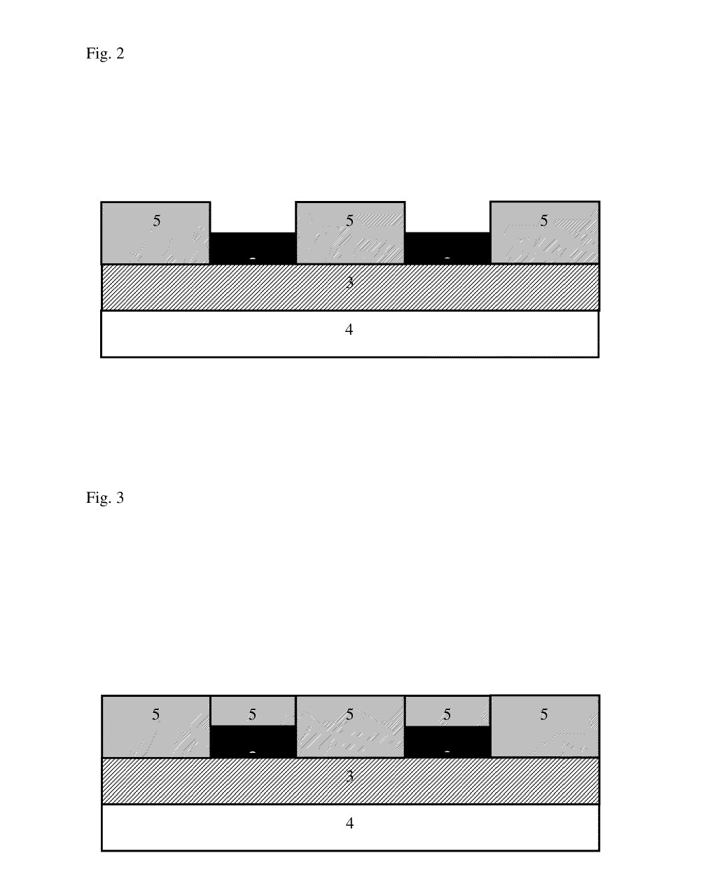

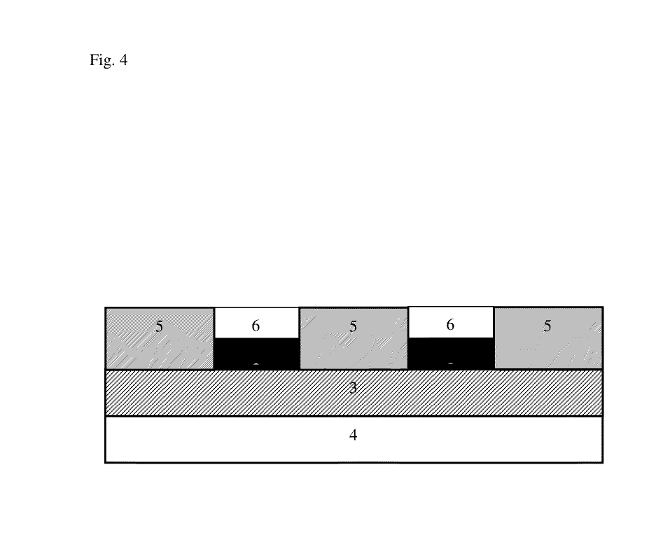

Referring more specifically to FIG. 2, in this embodiment, the upper surface of the electrically conductive layer 2 is substantially free of any coating. Referring to FIG. 3, in this embodiment a masking layer 5 is overlaying or partially overlaying the upper surface of the electrically conductive layer 2. Non-limiting examples of the masking layer 5 are plastic film, a layer of paint, or a layer with a special function as required. A white or silver masking layer 5 is preferred as it increases the reflectivity and brightness of the adjacent light guide in the BLU. In yet another embodiment, as illustrated in FIG. 4, an anti-oxidation layer 6 is overlaying or partially overlaying the upper surface of the electrically conductive layer 2. The anti-oxidation layer 6 is electroplated onto the electrically conductive later may be of any appropriate material. Such non-limiting examples of the anti-oxidation layer include tin, gold, silver, or an alloy.

In one embodiment, the composite 1 comprises a metal copper clad laminate (MCCL), which comprises an aluminum layer, a polyimide layer and a copper layer and the thickness is about 0.1 to about 1.5 mm.

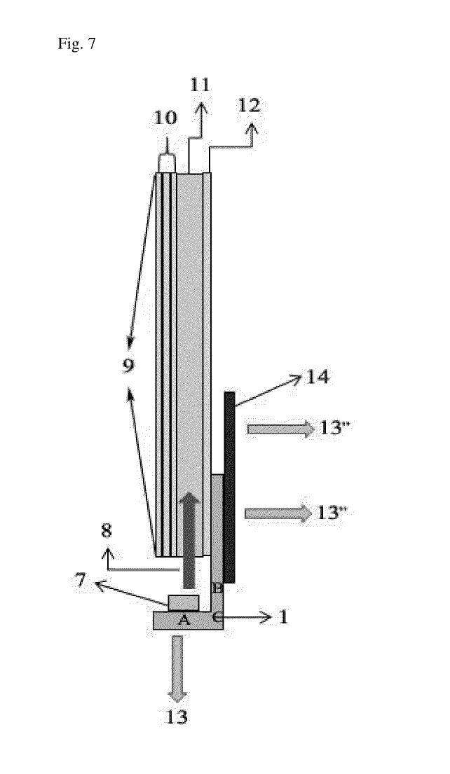

The heat-transfer apparatus further comprising a heat dissipation device and non-limiting examples of the heat dissipation device include graphite sheet (e.g. Hik@xy® and heat sink. In one embodiment, the heat dissipation device is in direct contact with the composite 1, as illustrated in FIG. 7. In another embodiment, the heat dissipation device is not in direct contact with the composite 1.

### Electrically Conductive Layer

The electric conductive layer 2 can be disposed on the dielectric layer 3, and embedded within the masking layers 5, as illustrated in FIG. 2. In an exemplary embodiment, the electrically conductive layer has a relative permeability of about 1 and/or a resistivity of less than about 1 and/or a thickness of about 10 to about 80 um or any value or range of values therebetween in 0.1 um increments. Examples of electric conductive layer can include, by way of example and not by way of limitation, the following: copper, silver, gold, or mixtures thereof. In one embodiment, the electrically conductive layer is copper.

In one embodiment, embodiments can be manufactured such that the electric conductive layers are added to the dielectric layer 3, using light (e.g. laser light).

In another embodiment, embodiments can be manufactured by coating or laminating an electric conductive layer (such as copper) on the dielectric layer 3 and the undesired portion of the electric conductive layer is removed by a substractive method, such as etching or pulsed laser, leaving only the desired electric conductive traces on the dielectric layer.

### Metal Layer

The metal layer 4 used in some exemplary embodiments can be constructed of any appropriate material with a thickness about 0.1 to 2 mm or any value or range of values therebetween in about 0.01 mm increments. Examples of such metal layer 4 include, by way of example only and not by way of limitation, the following: aluminum, copper, stainless steel, magnesium alloy, titanium alloy or mixtures thereof.

### Dielectric Layer

The dielectric layer 3 used in the composite of the heat-transfer apparatus of an exemplary embodiment includes, in some embodiments, by way of example only and not by way of limitation, any non-conductive substrate with a thickness about 10 to about 100 um or any value or range of values therebetween in 0.1 um increments. Non limiting examples of non-conductive substrate include, by way of example only and not by way of limitation, the following: epoxy resin, fiber-filled epoxy, thermal filler, polyimide, polymer, liquid crystal polymer, and a combination thereof. In one embodiment, the dielectric layer is polyimide.

### Masking Layer

The masking layer 5 may be composed of any suitable material. Examples of such suitable materials for the masking layer 5 include, but are not limited to, ink and dry film. The masking film 5 can be applied to the dielectric layer 3 and by various methods known in the field, such as by screen printing for ink or laminating process for dry film.

### The Method of Forming the Heat-Transfer Apparatus

The composite 1 of at least some exemplary embodiments can be manufactured by press molding the metal layer 4, the dielectric layer 3 and the electrically conductive layer under heat.

The heat transfer apparatus of at least some embodiment can be formed by press molding the formed composite 1 at room temperature into a plastically deformed composite.

The amount of pressure for press molding can play an influential role in avoiding crack formation in the plastically deformed section C. In one embodiment, about 15 to about 25 tons is used to press mold a composite 1 with a thickness of about 0.6 mm

### The Backlight Apparatus

FIG. 7 illustrates a backlight apparatus according to an exemplary embodiment, which comprises a generally “L” shaped laminate 1 and one or more LEDs 7, which transmit light to the backlight unit 9. The LED 7 is in conductive heat transfer communication with the first leg A of the “L” shaped laminate 1.

The cross-section of the “L” shaped laminate 1 lying on a plane normal to a longitudinal axis of the laminate having the generally “L” shape includes a metal sub-section 4, a dielectric sub-section 3 and one or more electrically conductive sub-sections 2, each of the sections being generally “L” shaped, wherein the first leg A and the second leg B of the “L” shaped laminate 1 are connected together via a plastically deformed section C. In one embodiment, at least one of the legs of the “L” shaped laminate 1 has a zig-zag shape to accommodate the backlight unit (BLU) 9.

The backlight apparatus further comprises a heat dissipation device 14, which can touch or be in an alternate form of contact (e.g., indirect contact via another component interposed therebetween) with the composite 1.

Again referring to FIG. 4, the cross-section of the “L” shaped laminate 1 also includes a masking layer 5, wherein a surface of the masking layer 5 along the longitudinal axis of the laminate is intermittent, thereby forming an electrically conductive path between the LED 7 or other circuit and the electrically conductive sub-section 2.

The BLU comprises prism sheet and diffuser sheet 10, a light guide 11 and a reflective film 12. The light from the LED 7 is reflected to the light guide 11 via pathway 8.

### The Method of Heat Dissipation in a Backlight Apparatus

In an exemplary embodiment, there is a method of heat dissipation in a backlight apparatus, comprising the actions of:
a) conducting heat from an LED 7 to a first leg A of a generally “L” shaped laminate 1 (as illustrated in FIG. 7);
b) a portion of the heat is dissipated to the ambient air via pathway 13; and
c) the remaining heat passes through the first leg A to a second leg B of the generally “L” shaped laminate 1 through a plastically deformed section C, and the heat is dissipated to the ambient air via pathway 13″.

In one embodiment, the heat in the second leg B of the generally “L” shape laminate 1 is passed to the heat dissipation device 14, which enhances heat dissipation in the backlight apparatus.

While various embodiments have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A heat-transfer apparatus, comprising:
a composite, including:
a metal layer;
a dielectric layer located on the metal layer; and
one or more electrically conductive layers located on the dielectric layer on an opposite side from the metal layer;
wherein the composite is a plastically deformed composite such that a surface of the composite at a first leg has a first planar area that is at an angle of between a value of about 70 degrees and a value that is less than about 180 degrees, or greater than a value of about 180 degrees to less than a value of about 360 degrees to a second planar area of a second leg.

2. The apparatus of claim 1, wherein:
the strata of the layers below the surface extends from the first leg to the second leg.

3. The apparatus of claim 1, wherein:
the strata of the layers below the surface is generally uniform from the first leg to the second leg.

4. The apparatus of claim 1, wherein:
the composite is substantially free of adhesives.

5. The apparatus of claim 1, wherein:
the apparatus further comprising a heat dissipation device that is attached to the composite.

6. The apparatus of claim 5, wherein the heat dissipation device is a graphite sheet.

7. The apparatus of claim 1, wherein:
a plastically deformed section of the composite between the first planar area and the second planar area has a curvature with a bend radius of about 0.1 mm to less than 2 mm.

8. The apparatus of claim 1, wherein:
a plastically deformed section of the composite between the first planar area and the second planar area is substantially free of cracks.

9. The apparatus of claim 1, wherein:
a plastically deformed section of the composite between the first planar area and the second planar area is effectively free of cracks.

10. The apparatus of claim 1, wherein:
a plastically deformed section of the composite between the first planar area and the second planar area is completely devoid of cracks.

11. The apparatus of claim 1, wherein:
the strata of the layers below the surface are substantially free of cracks.

12. The apparatus of claim 1, wherein:
the composite is configured such that an electricity flow across the plastically deformed section is interrupted when an electrical current is applied to the composite.

13. The apparatus of claim 1, wherein:
a cross-section of the composite lying on a plane substantially normal to the first planar area and the second planar area is in the form of about an “L” shape.

14. The apparatus of claim 1, wherein:
a plastically deformed section of the composite between the first planar area and the second planar area is non-thermoplastically deformed.

15. The apparatus of claim 1, further comprising:
a masking layer partially overlaying the electrically conductive layer.

16. The apparatus of claim 1, wherein:
an anti-oxidation layer partially overlaying the electrically conductive layer.

17. The apparatus of claim 1, wherein:
the composite is substantially free of thermoplastic and thermosetting materials.

18. The apparatus of claim 1, wherein:
the metal layer is at least substantially made up of a material selected from the group consisting of aluminum, copper, stainless steel, magnesium alloy and titanium alloy.

19. The apparatus of claim 1, wherein
the electrically conductive layer comprises copper.

20. The apparatus of claim 1, wherein
the dielectric layer comprises polyimide.
